(19) United States
(12) Patent Application Publication
(10) Pub. No.: US 2006/0159066 A1
(43) Pub. Date: Jul. 20, 2006

(54) Voice-over-internet protocol gateway

(76) Inventors: Alfred R. Nurnberger, Portland, OR (US); Ryan J. Mitchell, Portland, OR (US)

Correspondence Address: TIMOTHY E SIEGEL, 1868 KNAPPS ALLEY, SUITE 206, WEST LINN, OR, 97068, US

(21) Appl. No.: 11/038,975

(22) Filed: Jan. 19, 2005

(51) Int. Cl. H04L 12/28; H04J 3/16; H04L 12/56; H04L 12/66; H04J 3/22

(52) U.S. Cl. 370/352; 370/401; 370/466

(57) ABSTRACT

A VOIP gateway that includes a web server. The gateway is configured to accept configuration data over the Internet by way of the web server. In one embodiment, the VOIP gateway includes a telephone line connection interface, able to connect to a telephone line that may carry a plurality of channels. The gateway also includes an Internet connection interface and a channel assigner, user configurable to assign a subset of the channels from the telephone line connection interface to telephone calls incoming from the Internet connection interface that are directed to telephone numbers having a shared characteristic.

### BACKGROUND OF THE INVENTION

Voice-over-internet protocol (VOIP) telephony has become increasingly popular because it is generally less expensive for the party placing a telephone call than alternative systems. Accordingly, several vendors have begun offering VOIP “gateways,” that is electronic devices for assembling packets of data from the Internet to create a voice signal, and for receiving a voice signal and creating a sequence of data packets that are sent over the Internet to a destination.

Unfortunately, it has proven very difficult to create a VOIP gateway that may be easily configured and put into service by someone other than a professional trained in an arcane computer language. Many of the configuration choices do not occur in other environments, so most users are not familiar with the terms that can be used to describe these choices. This problem has slowed the adoption of VOIP technology.

Another problem may be encountered in the initial installation of the VOIP gateway. After the VOIP gateway has been connected to the Internet it may be used to communicate with technical support from the gateway provider. Before the gateway is connected to the Internet, however, there is no easy way for the user, who may be in a foreign country, to communicate with technical support, so that they can help the user connect to the Internet. This can result in a cycle of frustration on the part of the person who wishes to configure and use the gateway, but is stymied by the first step.

In addition, generally available VOIP gateways typically have no way to direct calls to different channels of a T1 line depending on the characteristics of the telephone number entered. This presents a difficulty to the user who wishes to handle different T1 line channels, or groups of channels differently from others.

### SUMMARY OF THE INVENTION

In a first separate aspect, the present invention is a VOIP gateway that includes a web server. The gateway is configured to accept configuration data over the Internet by way of the web server.

In a second separate aspect, the present invention is a VOIP gateway that includes a telephone line connection interface, able to connect to a telephone line that may carry a plurality of channels. The gateway also includes an Internet connection interface and a channel assigner, user configurable to assign a subset of the channels from the telephone line connection interface to telephone calls incoming from the Internet connection interface that are directed to telephone numbers having a shared characteristic.

In a third separate aspect, the present invention is a VOIP gateway that includes an interface adapted to be connected to a display screen and an interface adapted to be connected to a data input device. In addition, the gateway includes an electronic network that is adapted to display on the display screen a sequence of displays, each one of the displays showing prompts to guide a user in inputting configuration data into the VOIP gateway by way of the interface adapted to be connected to a data input device.

In a fourth separate aspect, the present invention is a VOIP gateway that includes an interface adapted to be connected to a standard telephone set and wherein the VOIP gateway is adapted to prompt a user by way of a telephone set connected to the interface, to enter an Internet address by way of the telephone set.

In a fifth separate aspect, the present invention is a VOIP gateway that includes an interface adapted to be connected to a standard telephony line and an interface adapted to be connected to the Internet. A maximum number of telephone calls may be processed simultaneously by the gateway and when an additional telephone call is received at a time when the gateway is processing the maximum number of telephone calls, the additional telephone call is placed in a call progress queue and held for up to a maximum time period before either being connected, if a line becomes available, or rejected if no line becomes available.

The foregoing and other objectives, features and advantages of the invention will be more readily understood upon consideration of the following detailed description of the preferred embodiment(s), taken in conjunction with the accompanying drawings.

### BRIEF DESCRIPTION OF THE DRAWINGS

FIG. 1 shows a high level block diagram of a VOIP gateway according to the present invention.

FIG. 2 shows a flow chart of the initial connection to the Internet algorithm of the VOIP gateway of FIG. 1.

FIG. 3 shows a gateway log in screen, adapted to prevent unauthorized access to the VOIP gateway of FIG. 1.

FIG. 4 shows an initial display screen of a Registration Wizard that is part of a graphical user interface (GUI) that is made available to a user by the VOIP gateway of FIG. 1.

FIG. 5 shows a subsequent display screen of the wizard of FIG. 4, prompting the user to name the registration.

FIG. 6 shows a subsequent display screen of the wizard of FIG. 4, prompting the user to enter critical information to connect with an internet server of the long distance carrier being registered.

FIG. 7 shows a subsequent display screen of the wizard of FIG. 4, prompting the user to specify the scope of usage of the registration.

FIG. 8 shows a subsequent display screen of the wizard of FIG. 4, prompting the user to specify the encoding scheme for DTMF tones, in addition to other items.

FIG. 9 shows a subsequent display screen of the wizard of FIG. 4, prompting the user to name the registration.

FIG. 10 shows a subsequent display screen of the wizard of FIG. 4, prompting the user to enter data by which the gateway is identified to a long distance carrier.

FIG. 11 shows a subsequent display screen of the wizard of FIG. 4, reporting the results of the registration effort.

FIG. 12 shows a display screen, displaying a list of completed registration and permitting a user to launch the registration wizard shown in FIGS. 3-10.

FIG. 13 shows a display screen, showing a least cost routing edit form.

FIG. 14 shows a least cost routing summary screen.

FIG. 15 shows a hunt group line reassignment screen.

FIG. 16 shows a channel group management screen.

### DETAILED DESCRIPTION OF THE PREFERRED EMBODIMENT(S)

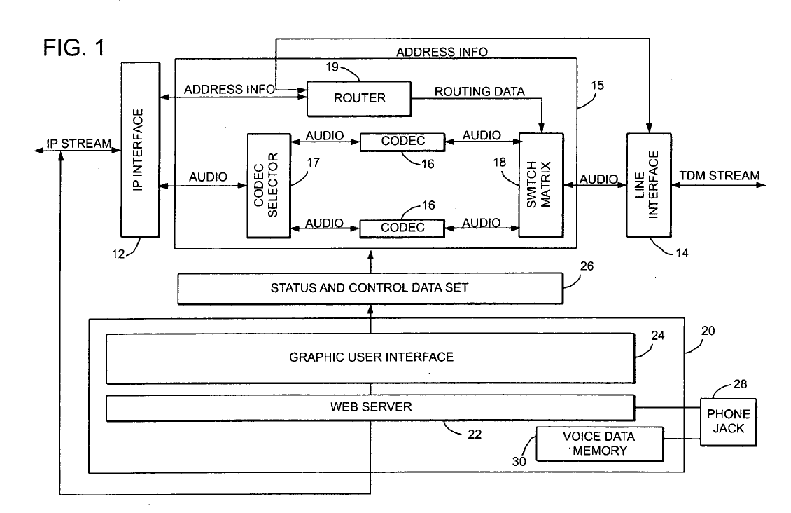

Referring to FIG. 1, which illustrates the workings of a VOIP gateway in broad functional blocks, a VOIP gateway 10 according to the present invention, includes an internet protocol (IP) interface 12, which would typically connected to a DSL line, or a cable modem. Also a standard telephony line interface 14 which is typically connected to T1 lines, if the gateway 10 is being used in the United States. If the gateway 10 is placed in use in Europe or another place using the European standard, E1 lines would be used. For Japan and other places using the Japanese standard, a J1 line would be used. In an alternative preferred embodiment, gateway 10 includes additional functional blocks that permit it to serve as a private automated branch exchange (PABX).

A signal routing and processing block 15, includes a set of codecs 16 and a codec selector 17, which compress the voice data and decompress the internet data, according to which way the data is directed. This is all done in accordance with already well known principals, so it is not described here. A switch matrix 18, connects each call incoming from interface 12 to a T1 line channel of interface 14 in accordance with a set of rules, which will be described below.

A nonvolatile memory assembly 20, a webserver 22 and a graphical user interface memory 24, which includes the information necessary to display a graphical user interface for guiding a new user through a set-up procedure and for facilitating later adjustments to the operation of gateway 10. This process is used to create a status and control data set 26, which is used to control processing block 15.

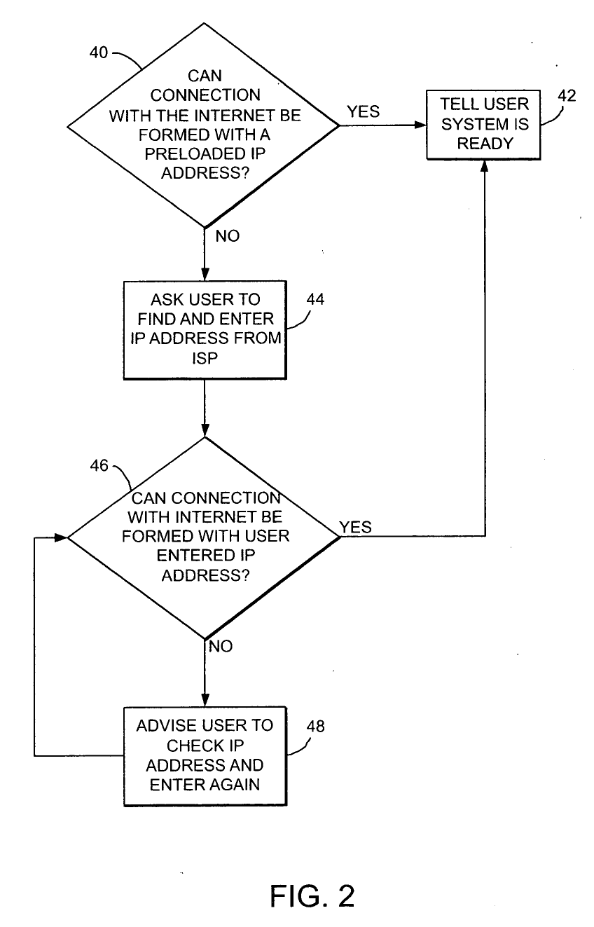

Referring to FIG. 2, when a user first begins to configure his gateway 10, the first step is to connect the gateway 10 to the Internet. Once gateway 10 is connected to the Internet, the user's way of communicating with gateway will be through the Internet. Accordingly, prior to connecting to the Internet there must be some temporary means of communicating between gateway 10 and the user, to facilitate the process of connecting to the Internet.

This means is a telephone, which comes packaged with the gateway 10 and which is plugged into a phone jack 28 (FIG. 1) that is a part of gateway 10. Gateway 10 first checks to see if it has a preprogrammed Internet address to use and if so attempts to connect to the Internet, using this address. If a connection is made (decision box 40), the user is advised that the gateway 10 may now contact his gateway 10 by way of the Internet (block 42). If no connection is formed a recorded voice message 30 (FIG. 1) is sent over the telephone jack (block 48), advising ing the user to locate the Internet address assigned to him by his Internet Service Provider (ISP) and enter into the telephone keypad. This number is read back to the user, and if confirmed, gateway 10 attempts to form an Internet connection with a home base Internet address using the Internet address entered. If this succeeds (decision box 46) the user is advised that he may now contact his gateway 10 over the Internet (block 42). If this does not succeed the user is notified and asked to find a different Internet address or to contact the ISP (block 48).

After the Internet connection has been formed the telephone can be used to form a VOIP connection to user support by taking the telephone off hook and/or dialing a short telephone number. A VOIP connection may also be easily placed to the sales department of the gateway vendor, to encourage greater sales contacts.

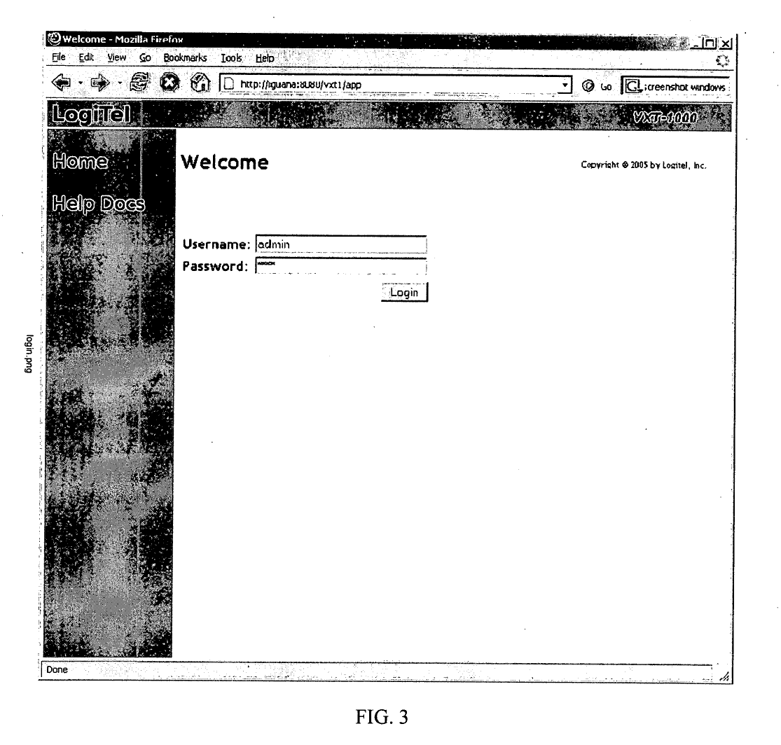

Referring to FIG. 3, after gateway 10 becomes accessible via the Internet a user must logon through a username and password that has been assigned to him by the vendor of gateway 10. He then may change these items to personalize them.

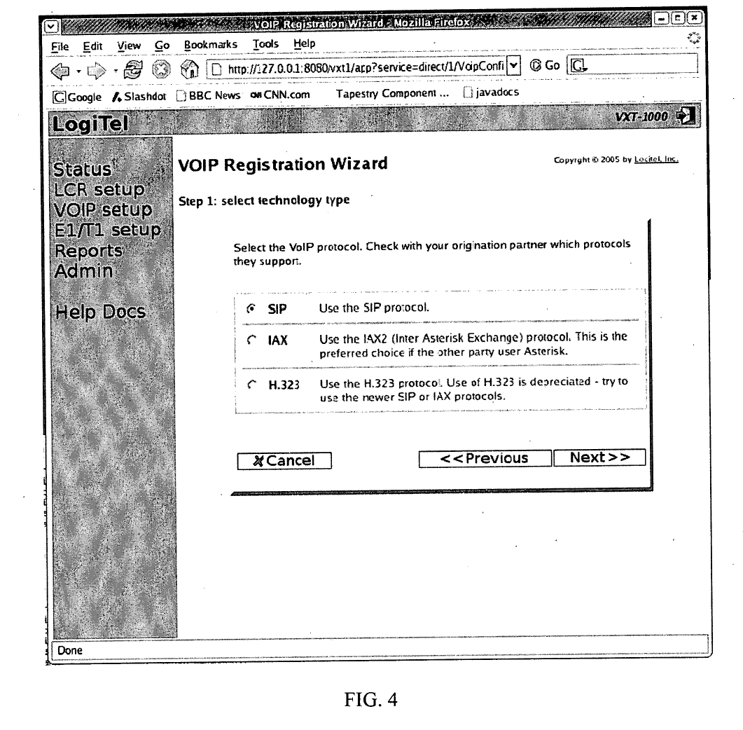

FIGS. 4-11 show a sequence of display screens that are used to guide a new user through a registration procedure. The gateway 10 is designed to communicate over the Internet with the gateway user, by displaying a set of prompting screens and accepting input over the Internet.

Previously available VOIP gateways were constructed according to the notion that configuration of a VOIP gateway was something that was so technically specialized as to only be performed by trained specialists. The present inventors, however, have discovered that this is not the case, and that, contrary to what the experts had previously believed, with some explanation and guidance the average person can configure a VOIP gateway.

FIG. 4 shows a display that is shown to a user when the user first begins to register the gateway 10 to communicate with a particular long distance carrier (eg. Sprint or ATT) over IP interface 12. Display 40 guides the user through the selection of data compression algorithm, which may be designated by the acronym SIP, IAX or H.323. Neither the user of gateway 10 nor the reader of this application needs to know a great deal about these algorithms. By the time the user obtains his gateway 10 and begins to configure, he should already have contacted a long distance carrier and learned which data compression algorithm that carriers has chosen to use in sending data over the Internet to gateway 10. The user simply selects the appropriate choice and proceeds to the next display screen by pressing the “enter” key, as will no doubt be a familiar action to the vast majority of users.

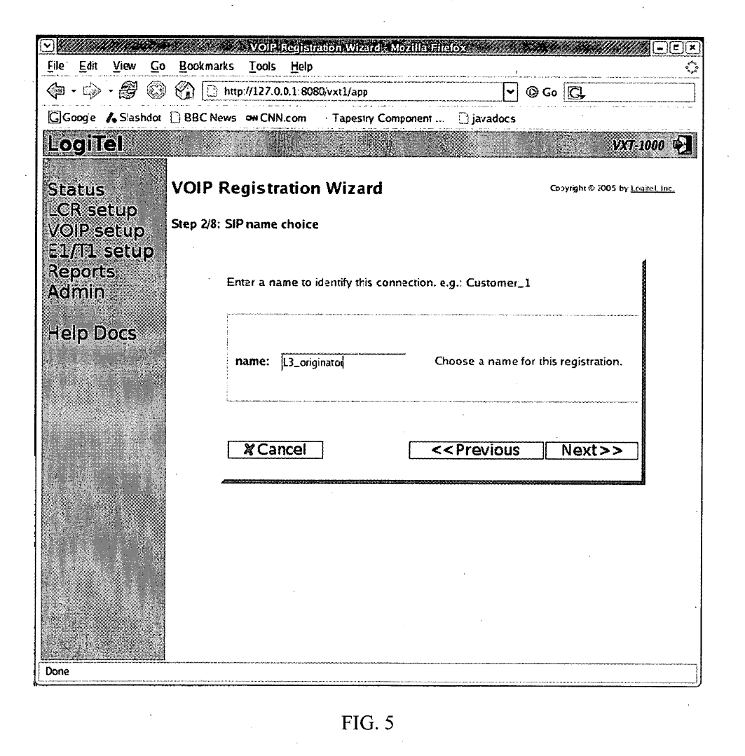

FIG. 5 shows a display screen in which the user is prompted to enter a name by which he will refer to the data set entered during the registration process. The user may choose to give the data set the name by which the long distance carrier to which the data set applies is generally referred to by the public, i.e. “Sprint” or “ATT.”

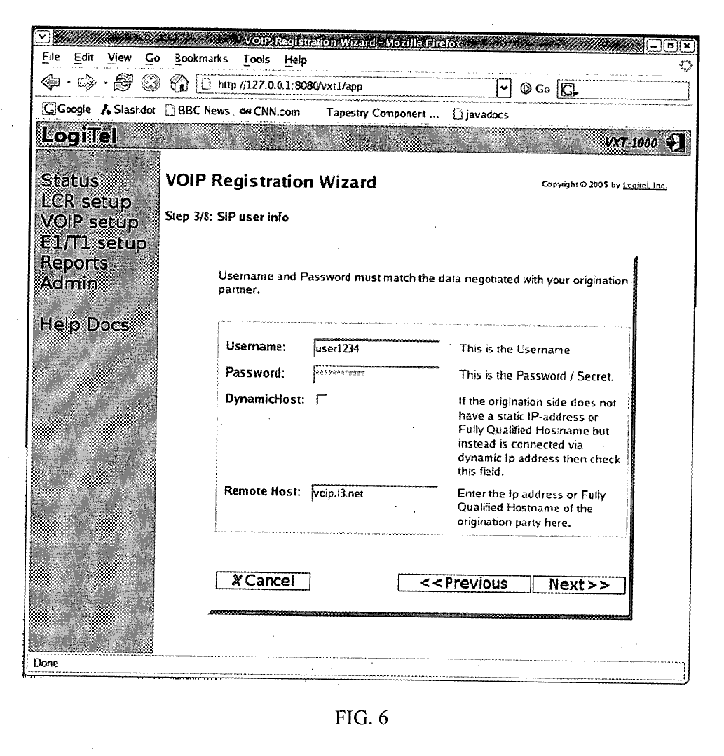

The screen shown in FIG. 6 permits the user to enter a username and password for the long distance carrier being registered to identify itself by. This typically should have already been supplied to the user at the time he enters the set-up wizard. If, in addition, or in lieu of username designation, the user wishes to accept all calls originating from a particular internet address, he can enter that address in the Remote Host entry blank.

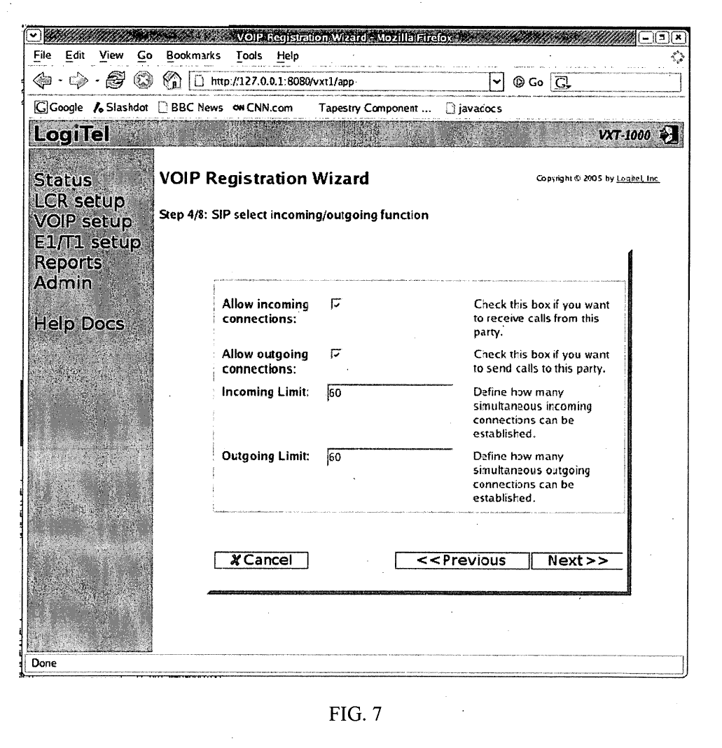

Referring to FIG. 7, a screen is shown by which the user may choose to use the long distance carrier being registered only for incoming calls, only for outgoing call or for both. The “remote does NAT” must be set if a cable modem is being used for the connection between gateway 10 and the Internet, because the internet address of gateway 10 will be periodically changed in this configuration. The “do registration” box must be checked if another gateway is being used in conjunction with the gateway being configured.

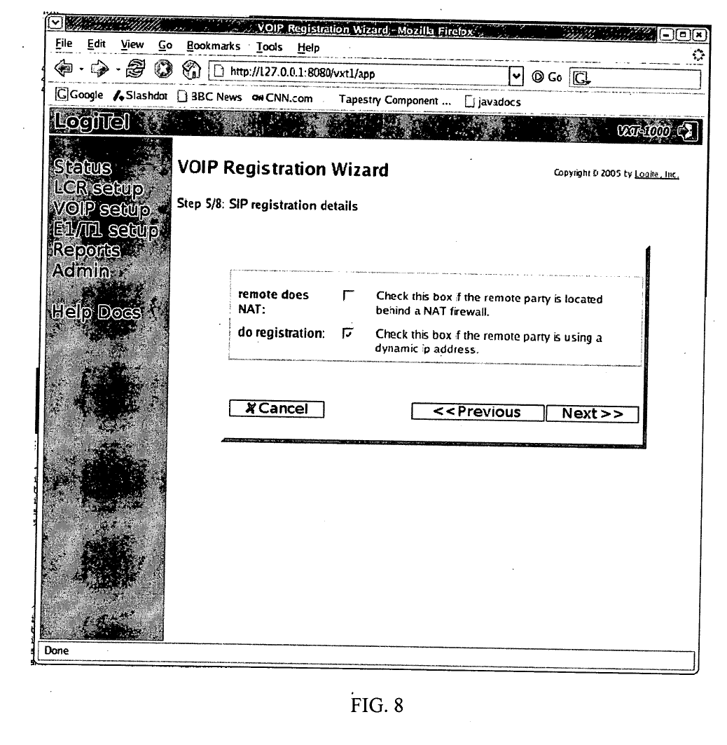

Referring to FIG. 8, the user must choose a way that dual tone modulated frequencies (DTMF, i.e. “touch tones”) are to be encoded. In one method, they are sampled periodically. In other methods, a simple notation is made that, for example, dial pad key “5” has been pressed. Again in making his selection, the user would simply refer to information received from the long distance carrier of FIG. 2. The user may also select an incoming limit and outgoing limit of telephone calls to be handled by the carrier. If the carrier has been parsimonious in negotiation, the user may want to limit the number of calls to a figure on the order of 5, and save space for more generous carriers.

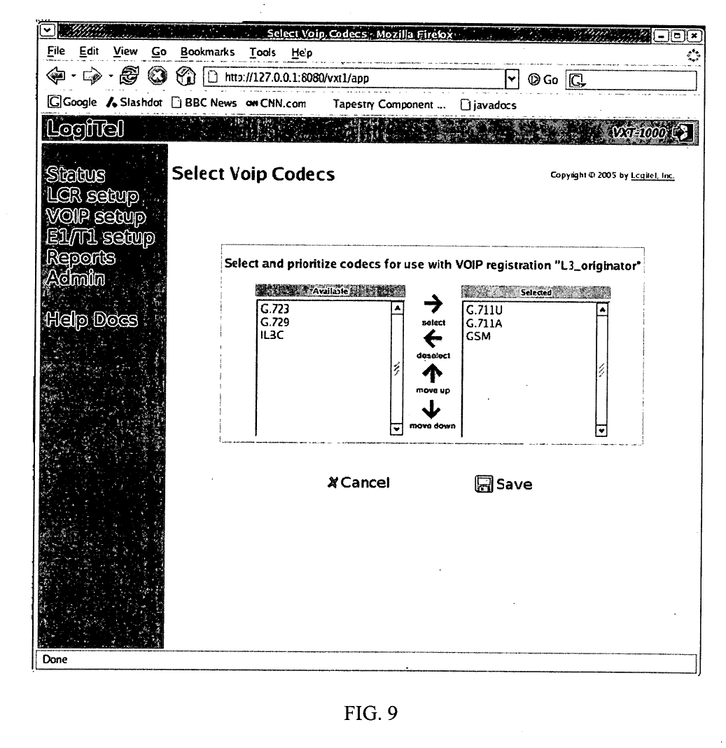

Referring to FIG. 9, the user may select and prioritize the VOIP codecs (compression schemes) to be used with the carrier. Either party (long distance carrier and gateway 10) may use a first codec when bandwidth is at a premium, and a different codec when bandwidth is freely available, as there is generally an inverse relationship between codec data compression ratio and sound quality.

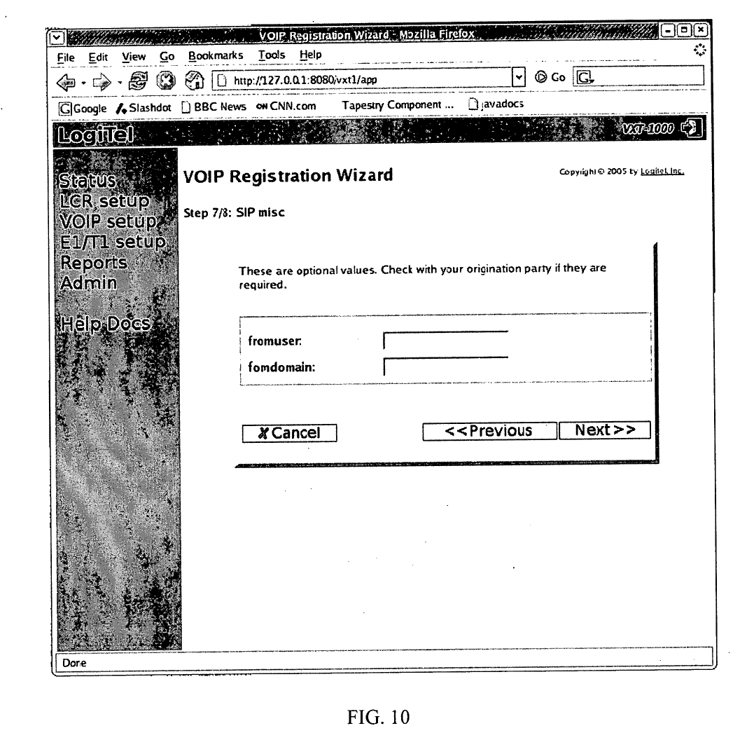

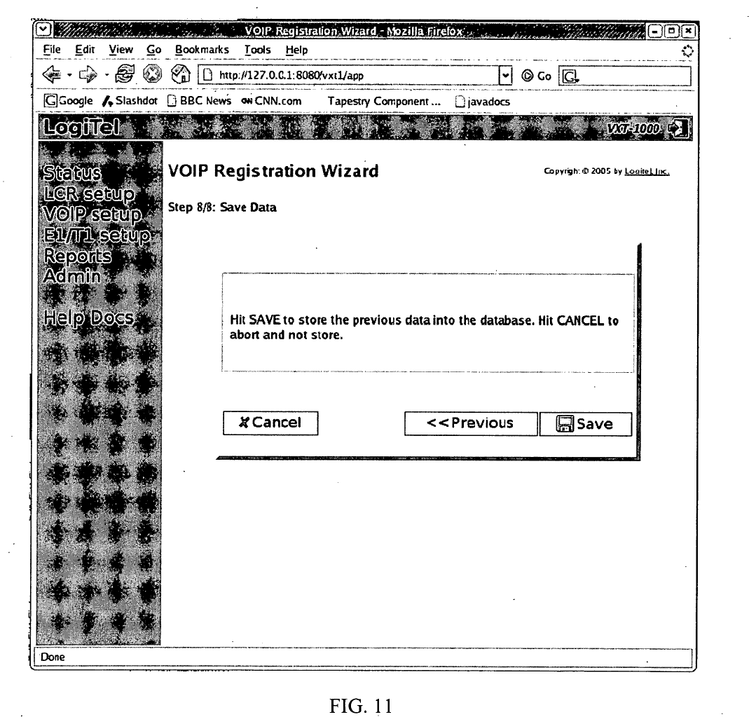

Referring to FIG. 10, the “fromuser” and “fromdomain” are the unique identifiers for the gateway 10, when communicating with the carrier. The user is also given the opportunity to test the registration. Referring to FIG. 11, the user is advised of the success of the registration.

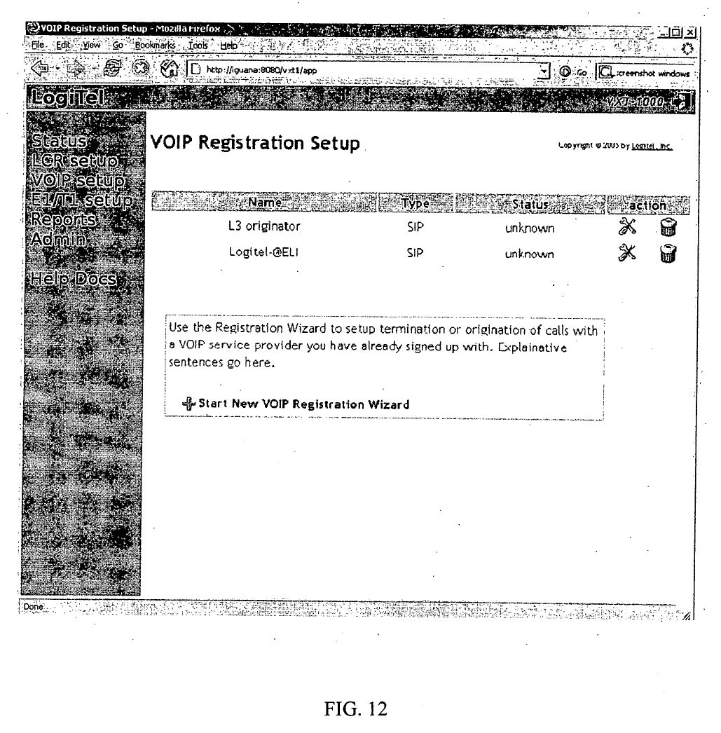

The user can go through the registration process with a number of different carriers, in order to generate a continuous stream of business, some from each carrier. FIG. 12 shows a screen providing a summary of the completed registrations and permitting a user to begin a new registration process.

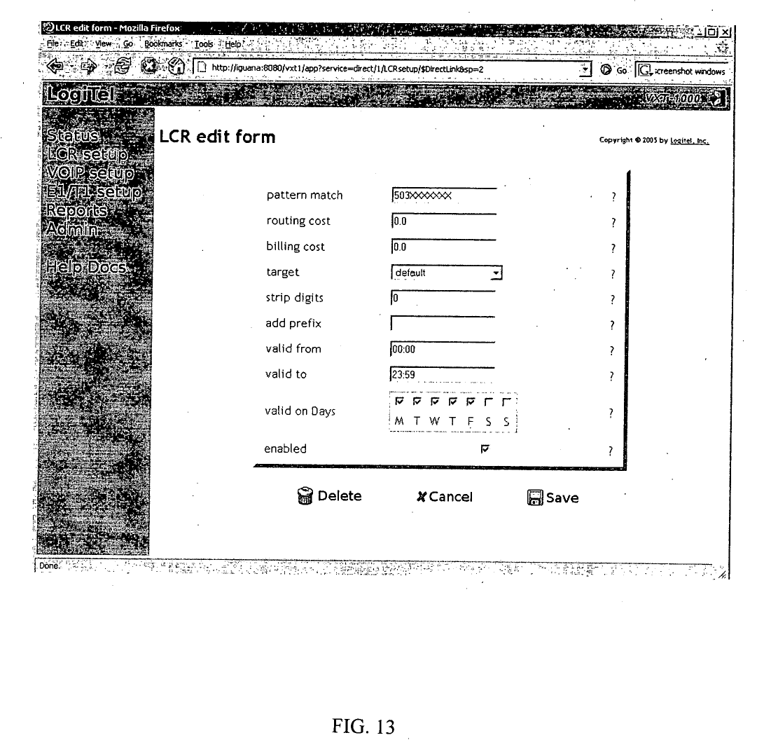

FIG. 13 shows a least cost routing (LCR) edit form. The “pattern match” prompt 50 permits a user to indicate a set of telephone numbers incoming over IP interface 12, for which the rule to be entered should apply. In the instance shown, the rule should apply to every such telephone number having the 503 area code. The “target” prompt and drop down menu 52 permits a user to select a set of T1 channels to which these calls should be directed.

For example, a T1 line could include some channels (“360 channels”) that function as telephone lines originating in the 360 area code (southwest Washington state) and other channels (“503 channels”) that function as telephone lines originating in the 503 area code (northwestern Oregon). The least cost routing, in this instance, would be to use the 503 lines for calls to telephone numbers having the 503 area code and using the 360 lines for calls to telephone numbers having the 360 area code. The T1 channels that correspond to 503 lines may be grouped together, into a target named, for example, “QWEST trunks at PDX.” This type of grouping is generally termed a “hunt group.”

Routing cost is the amount that it costs, per minute, to route a call according to the rules given. The billing cost, is the amount per minute that the carrier will be charged. Routing cost minus billing cost represents the profit per minute that the gateway owner should realize. In some instances, it may be necessary to strip away digits, for example the international calling prefix, or add a prefix, for greater routing freedom, to complete a telephone call. In addition, the ability to activate the routing specified only during certain times is provided. This is useful in a situation in which the tariffs vary according to day or time of day.

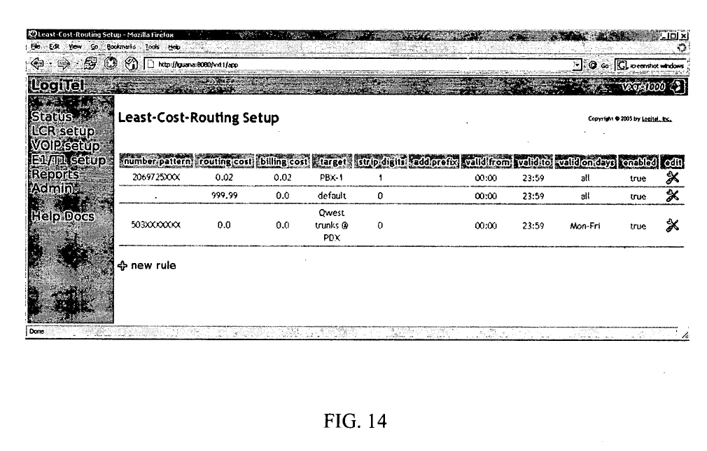

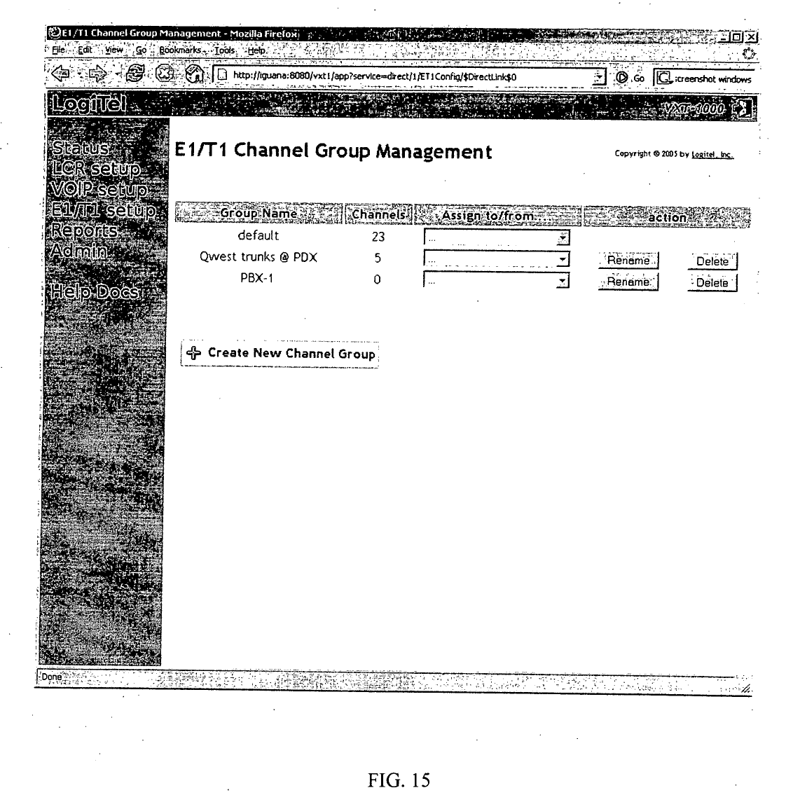

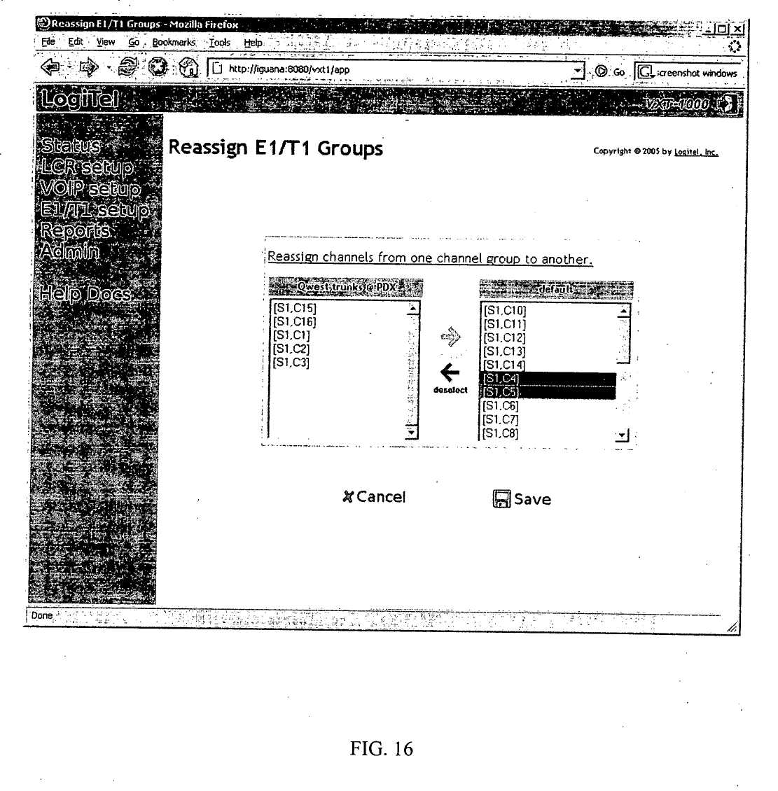

In FIG. 14, a summary of routing assignment is provided to the user. In FIG. 15, a hunt group reassignment screen is shown. The user may at some point decide that he would like one or more T1 channels reassigned from one apparent origination point to another. For example he may want one more 360 line (due perhaps to population growth in southwest Washington) and be willing to surrender a 503 line in return. To effect this object, he would contact the T1 provider to have the change made. Contemporaneously with the change going into effect, he would have to reassign the line from the 503 hunt group to the 360 hunt group. In the screen of FIG. 15, the user may choose a hunt group from an “Assign to/from” drop down menu, at which point the screen of FIG. 16 appears, permitting channel reassignment between the hunt group chosen from the drop down menu and the hunt group in the same line from the “Group Name” column. The screen shown in FIG. 16 is adapted to permit the reassignment of a channel in a user friendly manner.

Another feature of gateway 10 is call progress queuing. If all the channels of the interfaces 14 are being used and an additional telephone call is received on interface 12, it may be kept waiting, with a ringing signal sent back to the caller, for a user specified amount of time. When a channel of interface 14 is freed, the call is promptly connected. This feature permits the user of gateway 10 to keep his gateway more fully employed with telephone calls than it would otherwise be. With 48 channels available the waiting period would typically be quite brief. The maximum waiting period may be set to a short enough duration so that the telephone caller and his called party will not note a discrepancy, with the called party noting that he answered on the first ring and the calling party insisting that the phone rang several times.

The terms and expressions that have been employed in the foregoing specification are used as terms of description and not of limitation. There is no intention, in the use of such terms and expressions, of excluding equivalents of the features shown and described or portions thereof, it being recognized that the scope of the invention is defined and limited only by the claims which follow.

1. A VOIP gateway, comprising:
(a) a web server; and
(b) said VOIP gateway being configured to accept configuration data over the Internet by way of said web server.

2. The VOIP gateway of claim 1, being further configured to send information designed to prompt a user to enter configuration information over the Internet by way of said web server.

3. The VOIP gateway of claim 1, further including functions associated with a private automated branch exchange (PABX).

4. A VOIP gateway, comprising:
(a) a telephone line connection interface, able to connect to a telephone line that may carry a plurality of channels;
(b) an Internet connection interface; and
(c) a channel assigner, user configurable to assign a subset of said channels from said telephone line connection interface to telephone calls incoming from said Internet connection interface that are directed to telephone numbers having a shared characteristic.

5. A VOIP gateway, comprising:
(a) an interface adapted to be connected to a display screen;
(b) an interface adapted to be connected to a data input device; and
(c) an electronic network adapted to display on said display screen a sequence of displays, each one of said displays showing prompts to guide a user in inputting configuration data into said VOIP gateway by way of said interface adapted to be connected to a data input device.

6. The VOIP gateway of claim 5, wherein said data input device that is connected to said input interface is connected to said input device by the Internet.

7. The VOIP gateway of claim 5, wherein said display screen and said input device are both part of a computer that is connected to said VOIP gateway over the Internet.

8. A VOIP gateway, comprising:
(a) an interface adapted to be connected to a standard telephone set; and
(b) wherein said VOIP gateway is adapted to prompt a user by way of a telephone set connected to said interface, to enter an internet address by way of said telephone set.

9. The VOIP gateway of claim 8, wherein said VOIP gateway attempts to connect to the Internet using said internet address and advises said user as to whether or not said attempt was successful.

10. A VOIP gateway, comprising:
(a) an interface adapted to be connected to a standard telephony line;
(b) an IP interface adapted to be connected to the Internet;
(c) wherein a maximum number of telephone calls may be processed simultaneously and wherein when an additional telephone call is received over said IP interface at a time when said gateway is processing said maximum number of telephone calls, the additional telephone call is placed in a call progress queue and held for up to a maximum time period before either being connected, if a line becomes available, or rejected if no line becomes available during said maximum time period.

11. The VOIP gateway of claim 10 which sends a “ringing” signal to said additional telephone call while it is being held in said call progress queue.
